(19) United States
(12) Patent Application Publication
(10) Pub. No.: US 2015/0099412 A1
(43) Pub. Date: Apr. 9, 2015

(54) FRAGRANCE ADHESIVE TAPE

(71) Applicant: SHURTAPE TECHNOLOGIES, LLC, Hickory (NC)

(72) Inventors: Pete Elafros, Hickory, NC (US); Daniel Eric Festa, Strongsville, OH (US); Windy Kathalikkatil, Denver, NC (US)

(21) Appl. No.: 14/509,169

(22) Filed: Oct. 8, 2014

Related U.S. Application Data
(60) Provisional application No. 61/888,663, filed on Oct. 9, 2013.

(51) Int. Cl. C09J 7/02; B05D 5/00; C11B 9/00; B05D 1/02

(52) U.S. Cl. CPC C09J 7/02; B05D 1/02; B05D 5/00; C11B 9/00; B05D 2401/00; C09J 2201/122; C09J 2205/102; C08K 9/10
USPC 442/1; 427/180; 427/421.1; 428/343; 428/323

(57) ABSTRACT

An adhesive tape comprising a fragrance and a method of making the same. The adhesive tape may be a duct tape, for example.

### CROSS-REFERENCE TO RELATED APPLICATIONS

This is a utility application claiming priority from U.S. provisional application Ser. No. 61/888,663, filed on Oct. 9, 2013, the entirety of which is incorporated herein by reference.

### FIELD OF THE INVENTION

The present invention relates to an adhesive tape, particularly to a duct tape or other adhesive tape having a fragrance.

### BACKGROUND OF THE INVENTION

There are numerous adhesive tapes in the marketplace. One such tape is duct tape which is known for its high level of adhesive strength. Duct tape typically is relatively thin having a thickness in a range of 5 mils to 12 mils. Duct tape can be torn by hand but when unrolled it has a tendency to adhere to itself.

Although consumers have used traditional duct tape for numerous purposes, there is a need for an alternative duct tape that has features of duct tape such as its durability, but yet provides different functionality, not only for those in the field of arts and crafts, but also in the fields of medical/emergency applications and textiles. The present invention addresses and provides a solution for this unmet need. Furthermore, there is also an unmet need in the marketplace for other types of adhesive tapes having a fragrance for crafting and other purposes.

### SUMMARY OF THE INVENTION

The invention relates to an adhesive tape having a fragrance and a method(s) of making the same.

The invention relates to a duct tape having a fragrance and a method(s) of making the same.

In another aspect of the invention, a method of making a fragrance adhesive tape, such as a duct tape, by powder encapsulation of a fragrance oil is provided.

In another aspect of the invention, a method of making a fragrance adhesive tape, such as a duct tape, by another method of encapsulation of a fragrance oil is provided.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates a method of providing a fragrance for use in making a fragrance adhesive tape in accordance with aspects of the invention.

FIG. 2 illustrates another method of providing a fragrance for use in making a fragrance adhesive tape in accordance with aspects of the invention.

FIG. 3 is a flow diagram illustrating a method of making a fragrance adhesive tape using a powder application in accordance with aspects of the invention.

FIG. 4 is a diagram illustrating a spray method of applying a fragrance to an adhesive tape roll in accordance with aspects of the invention.

FIG. 5 is an enlarged view of an area of application shown in FIG. 4.

### DETAILED DESCRIPTION OF THE INVENTION

The following detailed description of the embodiment(s) is merely exemplary in nature and is in no way intended to limit the invention, its application, or uses.

The invention relates to an adhesive tape having a fragrance and a method(s) of making the same. An adhesive tape generally has a structure comprising a base layer and an adhesive layer. The base layer has at least one edge and at least one surface, typically a top surface and a bottom surface. The adhesive layer comprises an adhesive. The adhesive layer is typically adjacent to the top surface or the bottom surface of the base layer. The base layer may be a paper, polymer, or other material. In accordance with the present invention, a fragrance is applied onto or incorporated into the structure of the adhesive tape. Methods of making a fragrance adhesive tape in accordance with the present invention are illustrated below with regard to a duct tape. However, other methods of applying the fragrance to the adhesive tape or incorporating the fragrance into the adhesive tape are contemplated as being within the scope of the present invention. The teachings of the present invention could be applied to other types of tapes such as painters or masking tapes, stationary tapes, packaging tapes, among others.

In an aspect of the invention, the adhesive tape is a duct tape. A duct tape generally comprises a polymer layer having at least one surface (typically a top and a bottom surface), a scrim below the surface of the polymer layer, and an adhesive layer. Thus, a duct tape comprises a polymer layer, an adhesive layer, and a scrim. Examples of commercially available duct tapes include the DUCK® brand duct tape of ShurTech Brands, LLC.

Examples of polymeric materials that are suitable as the polymer layer include, but are not limited to, polyester, nylon, polyethylene, vinyl, and other synthetic polymers. Preferably, the polymeric material is polyethylene. It is also preferable that the polymeric material is waterproof.

Examples of adhesives for adhesive layer include, but are not limited to, pressure sensitive adhesives including those having low and high tack, rubber based adhesives (synthetic and natural), acrylic adhesive, hot melt adhesive, microsphere adhesive, and any other adhesive suitable for use in duct tape construction.

Examples of materials that are suitable for the scrim include, but are not limited to, natural materials, synthetic materials, or combinations thereof. Examples of natural materials include, but are not limited to, cotton, cotton blends, silk, hemp, flax, and combinations thereof. Examples of synthetic materials include, but are not limited to, polypropylene, polyester, nylon, polyethylene, or combinations thereof. Natural materials are optionally treated or coated with synthetic materials. The scrim is in a form of a cloth, mesh, non-woven, or fabric. The scrim optionally comprises a pigment or a dye.

The polymer layer, adhesive layer, and a scrim are combined together to form a duct tape using a number of possible methods and configurations. In one configuration, the adhesive is between the polymer layer and the scrim. In another configuration, the polymer layer may be a coating on the scrim and the scrim is embedded in the adhesive so that the adhesive penetrates through and is exposed on the opposite side.

One such method of making a duct tape uses a calendar laminating process during which the layers are made separately and then laminated together under pressure. An alternative method involves injecting polyethylene pellets onto a thin film, then blending the film with the scrim while the plastic is hot, and then spreading the adhesive onto the film.

In an embodiment of the invention, a method of making a fragrance adhesive tape in accordance with the invention is illustrated below using a duct tape. However, it is contemplated as being within the scope of the invention that the method(s) of making could also apply to other types of adhesive tapes. In accordance with the invention, the method may comprise providing a fragrance and adding the fragrance to duct tape either in a process of making the duct tape or at the conclusion of processing (i.e. finishing) the duct tape.

In an aspect of the invention, the method comprises providing a fragrance. A fragrance may be present in a liquid medium such as an adhesive, coating, ink, or solution. The fragrance, for example, may be water-based or an oil. A fragrance oil may comprise a fragrant essential oil(s), aroma compound(s), fixative(s), solvent(s), or a combination thereof.

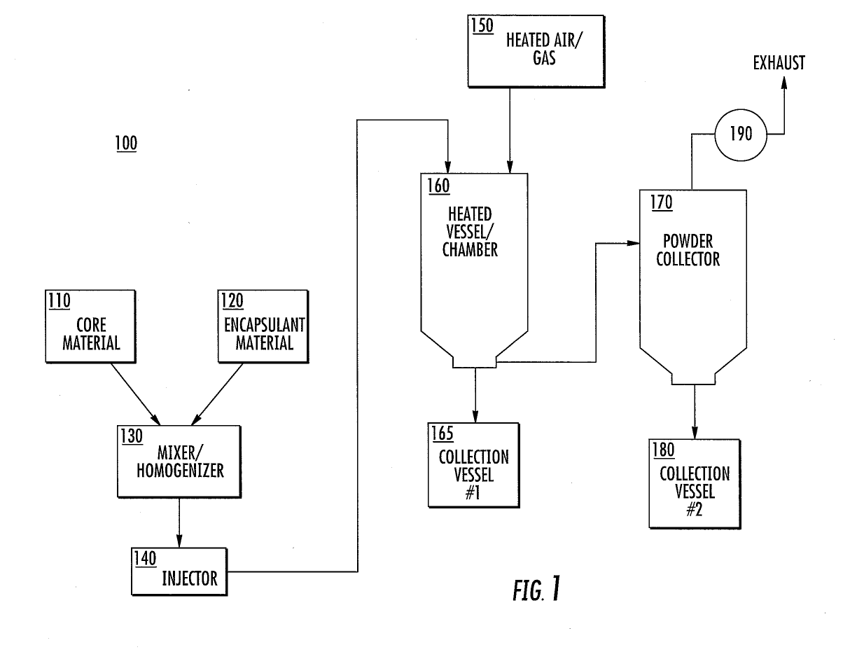

Referring to the figures, FIG. 1 is a diagram 100 illustrating a method of providing a fragrance for use in making a fragrance adhesive tape in accordance with aspects of the invention. Fragrance particles may be obtained by using spray drying with a powder encapsulation technique. A substance to be encapsulated is referred to as a core material 110. As shown in FIG. 1, core material 110 comprises a fragrance oil. An encapsulant material is used to encapsulate the core material. As shown in FIG. 1, encapsulant material 120 comprises an inert material(s) such as a modified starch, cellulose, sugar, gelatin, or other non-toxic material. The core material 110 and the encapsulant material 120 are combined and homogenized/mixed in a tank/homogenizer 130 as a suspension in water or other carrier to form a slurry. The slurry is then fed from the mixing tank/homogenizer 130 to an injector 140 and injected by the injector 140 into a spray dryer which is typically a heated vessel or chamber 160 that is heated by heated air or gas 150. As the slurry enters the heated vessel or chamber 160, the slurry is atomized. The small size of the drops results in a large surface area which dries the water quickly. As water dries, the encapsulant foams a hardened powder particle around the core material. The resulting fragrance particles may be sent to a first collection vessel 165 and/or sent to a powder collector 170 for filtration and/or collection. The collected particles are sent to a second collection vessel 180 for future use or application. Any exhaust may be released with the aid of an exhaust fan 190.

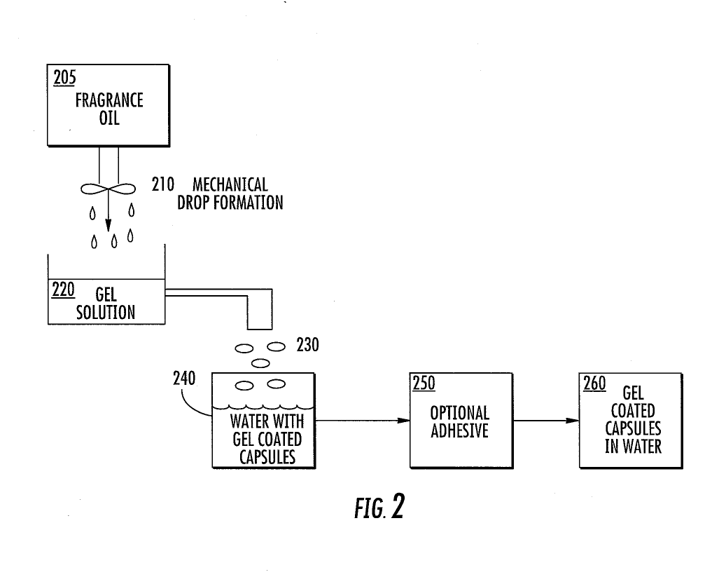

FIG. 2 illustrates another capsulation method of providing a fragrance for use in making a fragrance adhesive tape in accordance with aspects of the invention. FIG. 2 illustrates another type of encapsulation method. As shown in FIG. 2, a fragrance oil 205 is provided. The fragrance oil 205 undergoes mechanical drop formation 210. The oil drops enter a gelatin (gel) solution 220 forming gel coated capsules 230. The gel coated capsules 230 enter a water bath 240 and form a slurry or a controlled mixture. The gel capsules 230 may optionally be treated with an adhesive 250 before proceeding to collection at point 260. In an aspect of the invention, the weight percent of solids in the gel capsule and water slurry is in a range of 50% to 80% solids, preferably 65% to 75% solids. The balance of the slurry is water. The weight percent of core material in the gel capsule is in a range of 30% to 65%, preferably 45% to 60%. The balance of the gel capsule is encapsulant material. The gel capsule/water slurry may be used in a liquid application process.

In another aspect of the present invention, the fragrance oil or other fragrance materials used are GRAS (Generally Regarded as Safe) which is an American Food and Drug Administration (FDA) designation. In an aspect of the invention, the fragrance materials are cosmetic grade for safe contact with the skin and considered non-toxic. However, food grade fragrances may also be used. For some applications such as industrial applications, materials are selected that are considered safe, but not for consumer use (i.e. consumption). In a further aspect of the invention, the encapsulant material including any inerts and the gel solution are also GRAS.

In an aspect of the invention, the method further comprises adding a fragrance to the duct tape during the process of making the duct tape.

The fragrance can be added directly to a liquid medium such as an adhesive or a coating. For example, a process utilizing either an oil-based or a water-based solution or liquid may be suited for use on higher volume applications or uses. Since changeover may be more difficult on higher volume manufacturing lines, a process using a liquid lends itself to insertion in various steps of the tape manufacturing process. There are a number of end uses suited to use with the liquid-based approach including, but not limited to, cloth reinforcement applications, and adhesive blends, among others.

In a cloth reinforcement application, a fabric substrate is used in conjunction with the duct tape. A fabric is used as a substrate to give the duct tape tensile strength and flexibility. The fabric can be soaked or impregnated with the liquid comprising the fragrance as it is fed into the manufacturing process. The fabric is then combined with a plastic and/or polymer material as a backing and then subsequently coated with adhesive. This method of application could be used for a longer duration, potentially lower threshold fragrance. Fragrance would work itself out of the fabric and through the substrate/adhesive combination. The level and duration of the fragrance can be controlled through the chemistry, amount of material used, and the specific construction of the tape.

In accordance with an aspect of the invention, another method of adding the fragrance to the duct tape is to incorporate the fragrance into an adhesive blend. A liquid, encapsulated material, and/or powder could be used within the adhesive as a form of or in combination with any of the other methods or mechanisms to impart the fragrance to the duct tape. The selection of the specific form is dependent on the process of constructing the tape, the performance of the fragrance, and the characteristics desired. Any one of the forms singularly or in combination may be blended into the adhesive.

Once liquid is exposed to air either in the unwinding or on the roll, evaporation or migration of the fragrance into the atmosphere or air will take place over time. This is desirable if the fragrance is to be immediately recognizable by a customer or user along with having a controlled, consistent layer fragrance being given off during a fixed period of time. The encapsulation method can be used to control the rate at which fragrance oil is released from the capsule. It is possible to construct the gel capsule so as to control rate of release, the brittleness of the capsule, and the wall thickness of the capsule. Thus, these variable may be adjusted to time control atomization and capsule breaking in accordance with the invention.

Still another method within the scope of the present invention is to incorporate or add the fragrance into the base layer. For example, if the base layer is a film layer, it may be possible to extrude the film with the fragrance in a polymer blend. Alternatively, the fragrance could be sprayed or otherwise applied to a surface or edge of the base layer or a surface or edge of the overall tape structure.

Still yet another method within the scope of the present invention is to include a primer coat between the adhesive and the film whereby the primer coat comprises a fragrance.

As noted throughout, one or more of these methods can be used alone or in combination to impart fragrance to a duct tape.

In another aspect of the invention, the method of making the fragrance duct tape comprises adding a fragrance to the duct tape at the conclusion of processing (i.e. finishing) the duct tape.

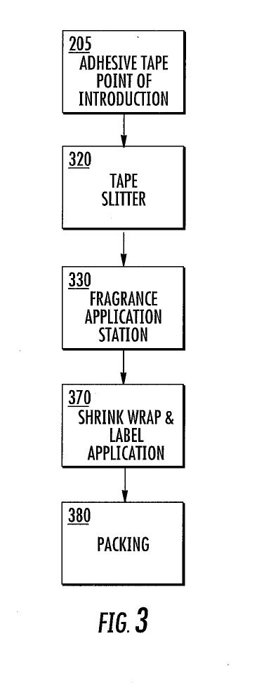

There are many methods in accordance with the invention for adding a fragrance to the duct tape at the conclusion of processing the duct tape. In one such method, the fragrance is in the form of a powder and is applied by a powdering application. As shown in FIG. 3, an adhesive tape is introduced at a feed point 310 and then fed to a tape slitter 320. From the tape slitter 320, the adhesive tape proceeds to a fragrance application station 330. To increase throughput or variety of fragrance products, the introduced adhesive tape is routed to one of many possible fragrance application stations. As shown in FIG. 3, after leaving fragrance application station 330, the fragrance adhesive tape may proceed to a shrink wrap and label application station 370. From the shrink wrap and label application station 370, the fragrance adhesive tape may proceed to a packing station 380.

At a fragrance application station, a powder can be applied to the edge of the adhesive tape (in a roll or sheet form) without adversely affecting the adhesive or top layer. Alternatively, the powder can be applied to any surface of the tape depending upon the desired application. This same process flow shown in FIG. 3 may be followed with other fragrance application methods at the fragrance application station 330.

With a powder, the essence of the fragrance is in an oil or other solvent that is contained within the encapsulant. Non-limiting examples of such encapsulant materials include, but are not limited to, calcium carbonate. The encapsulant holds the fragrance, and the encapsulated particle controls the rate at which fragrance is emitted. For example, the degree of porosity, if any, of the particle may be used to determine the rate of release of fragrance. The rate at which the fragrance migrates can be controlled (giving it a longer endurance).

The fragrance application station may comprise a bath. For example, a side of the roll of tape could be pressed up against the powder or other material in the bath or the tape could be run through a bath. Thus, a powder impregnation process can be used to make a fragrance duct tape. Preferably, the powder impregnation process is a mechanized process to impregnate or to apply a dry or a wet system to an edge(s) of the tape. The process allows for flexibility as to choice of fragrance for purposes of matching specific designs in the material and/or tape. In accordance with the method, a single roll or multiple rolls of tape are gripped or controlled utilizing the ID (inside diameter) of the core. A computerized robot or mechanized system can then place each edge (in sequence) into a liquid or powder bath. The duration, pressure, depth, movement, and other parameters of the tape are controlled when it is exposed or pressed into the bath. Then the robot or mechanized system will invert the rolls and repeat the process for the opposite side. Some characteristics of and variables for consideration in this process are set forth below.

One such process variable is duration. Duration is how long the tape is exposed in the bath. The bath may be a powder or a liquid into which the tape is pushed or submerged. The tape is pushed or submerged into the bath with the consideration of pressure, relative movement, duration, among others. If, for example, the tape is pushed into a liquid bath, then exposure to the liquid for absorption into the side of the tape is a consideration. If the tape is pushed into a powder, then pressure is a factor for bonding the powder to the adhesive. It is also possible to use relative movement, for example, by spinning the tape.

Pressure is any downward pressure of the tape into the bath or material. This may even be of more importance in encapsulated and powder mediums as compared to liquids for the reasons set forth above.

Relative movement is another process variable. As the tape moves into the bath, during the time in the bath, and as it is being removed from the bath there is a sequence or relative movement in reference to the bath.

For drying/post-application time, once each side is exposed to the bath there may be or is an amount of time that the tape should not see any contact with a foreign surface(s) and/or should have the environment controlled.

In a preferred aspect of the present invention, there is a precise and thorough cleaning of the outside diameter of the tape in most cases predominantly for visual characteristics and cleanliness of the tape product, particularly where the edge(s) of the tape are treated. With regard to the core configuration, it is desirable to control the core in width and placement within the tape.

Another method for applying the fragrance to the duct tape during manufacturing or at the conclusion of processing the duct tape is by a misting or spraying application. A liquid application of the fragrance can be applied at various stages of the duct tape manufacturing process or at the conclusion of processing the duct tape. The fragrance can also be applied at various locations on the tape such as on the adhesive surface, to the back surface of the tape or the sides or edges of the tape. The liquid composition can be modified depending upon the specific method.

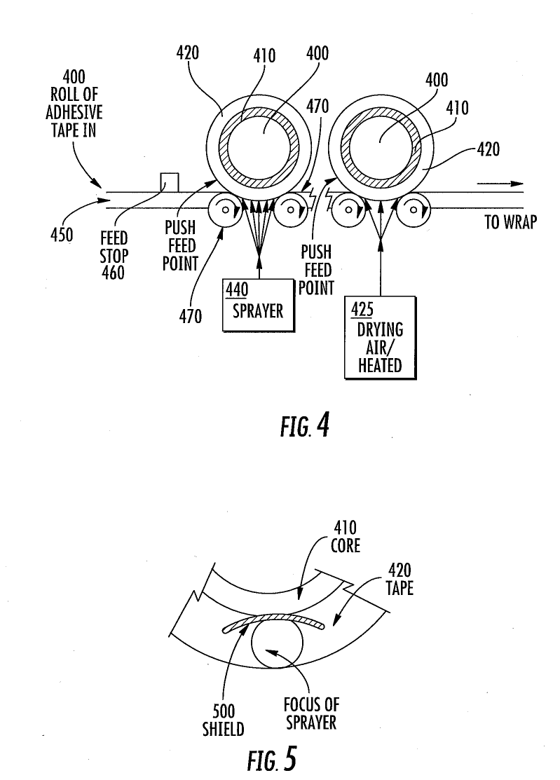

Referring to the figures, FIG. 4 is an illustration of a method of applying a fragrance to an adhesive tape roll in accordance with aspects of the invention. An adhesive tape roll 400 is fed onto a conveyor line 450 having a feed stop 460 with push feed points, and at least one set of rollers 470. The adhesive tape roll 400 is comprised of a core 410 and tape 420. The fragrance particles in water or other liquid 430 can be sprayed with a sprayer 440 onto a targeted area of the tape roll 400 for a targeted application. Further down the conveyor line 450, heated air 425 for drying may be applied to the tape roll 400. The tape roll 400 may proceed onto a wrap station (not shown) further downstream. FIG. 5 is an enlarged view of the area of application shown in FIG. 4. FIG. 5 illustrates that a shield 500 may be affixed to the tape roll so that none of the fragrance particles get on the core 410. There is also optional drying or post-processing of the duct tape provided that the fragrance is not degraded.

There are other features of the fragrance adhesive tape of the present invention. The fragrance duct tape optionally has a release “back coating.” The release “back coating” is a coating put on the back side of the tape (opposite side from the adhesive) that facilitates the tape coming off the roll (i.e. unwinding). The various finals could also be used for this purpose. A liquid could be blended in with the release coating such that when it is uncovered (i.e. the tape is unwound), the fragrance is exposed. A user would then have the sensory experience at that moment, probably being the most intense but continuing for some period of time. With regard to the encapsulated and powder forms, either of these forms could be mixed in with the back sizing or release coating to be exposed. These forms would likely perform similarly to the liquid but most likely have a lesser threshold fragrance and a longer continuing experience.

The duration of the fragrance or scent can last days to weeks. The fragrance may vary depending upon the desired aroma. The fragrance improves and enhances the duct tape. The fragrance can be present in the duct tape along with other features of the duct tape such as colors, patterns, and designs.

In another aspect of the present invention, although the fragrance duct tape is referred to as tape, the fragrance duct tape of the present invention encompasses number of configurations. For example, apart from a standard tape configuration some examples of the various configurations include, but are not limited to, tape on a roll, sheets, and cut shapes.

A tape roll is likely the most common configuration of the fragrance duct tape. It could be used for various purposes or in various configurations as mentioned above, and potentially in a variety of colors, decorative prints, or other features that would allow a visual correlation with the fragrance or enhancement of its value.

Another configuration for the fragrance duct tape is in sheets. The substrate with adhesive, decorated or in plain colors (with or without prints), could be in sheet form with a release liner. The release liner is a piece of paper (synthetic paper or polymeric film) to which the tape adheres such that a user pulls the tape from the liner to adhere the tape to a surface or to otherwise use the material.

Another configuration for the fragrance duct tape is in cut shapes. A substrate with adhesive comprising a fragrance could be shaped or die cut or otherwise formed in shaped units, on a release liner in a roll format. It is also possible that the tape itself is the shape, or the tape could be in discrete shapes on a release liner in roll format (for example, such as stickers).

Another method within the scope of the present invention is to add or incorporate the fragrance to an ink that would be used during or as part of the printing process for any printing on a duct tape.

For different types of end use applications including, but not limited to, medical and disaster relief, an antibacterial, anti-fungicidal, or antiviral material is used in the duct tape.

As noted throughout, one or more of these methods can be used alone or in combination to impart fragrance to a duct tape.

The methods of the invention may be used with other additives in the form of an oil, alone or in combination with a fragrance oil. The method of making an adhesive tape comprises providing an inert powder material an additive in a form of an oil, encapsulating the additive with the inert material to form an encapsulated powder particle, applying the encapsulated powder particle to a surface or an edge of an adhesive tape. There are any number of adhesive tapes that can be made using this method including, but not limited to, duct tape, packaging tape, among others. The adhesive tape may be in the form of a roll, sheet, or a die-cut shape. Numerous application methods may also be employed to apply the encapsulated powder particle to a surface or an edge of an adhesive tape.

In another method of making an adhesive tape, the method comprises providing an additive in a form of an oil, forming drops of the oil, submerging the drops of the oil in a gelatin bath to foam gelatin capsules comprising the oil, and applying the gelatin capsules to a surface or an edge of an adhesive tape. There are any number of adhesive tapes that can be made using this method including, but not limited to, duct tape, packaging tape, among others. The adhesive tape may be in the form of a roll, sheet, or a die-cut shape. Numerous application methods may also be employed, to apply the encapsulated powder particle to a surface or an edge of an adhesive tape. The method may further comprise treating the gelatin capsules with an adhesive. The method may further comprise spraying the gelatin capsules in a carrier on a surface or an edge of an adhesive tape.

It will therefore be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A fragrance adhesive tape comprising:
an adhesive tape comprised of an adhesive layer having an adhesive and a base layer having at least one surface and at least one edge, and
a fragrance.

2. The fragrance adhesive tape according to claim 1, wherein the adhesive tape further comprises a scrim.

3. The fragrance adhesive tape according to claim 1, wherein the fragrance is present on the adhesive tape on the at least one surface, at least one edge, or a combination thereof.

4. The fragrance adhesive tape according to claim 1, wherein the fragrance is present in the adhesive of the adhesive layer.

5. The fragrance adhesive tape according to claim 1, wherein the adhesive tape is in a form of a roll, a sheet, or a die-cut shape.

6. The fragrance adhesive tape according to claim 1, wherein the fragrance is in a form of an oil.

7. The fragrance adhesive tape according to claim 6, wherein the oil is encapsulated by a powder particle.

8. The fragrance adhesive tape according to claim 6, wherein the oil is encapsulated in a gelatin capsule.

9. The fragrance adhesive tape according to claim 1, wherein the fragrance is in the form of a powder.

10. The fragrance adhesive tape according to claim 1, wherein the fragrance is present in a liquid medium applied to the adhesive tape.

11. A fragrance duct tape comprising:
a duct tape comprised of an adhesive, a scrim, and a polymer layer having at least one edge and at least one surface, and
a fragrance.

12. The fragrance duct tape according to claim 11, wherein the fragrance is present on the adhesive tape on at least one surface, at least one edge, or a combination thereof.

13. The fragrance duct tape according to claim 11, wherein the fragrance is present in the adhesive of the adhesive layer.

14. The fragrance duct tape according to claim 11, wherein the adhesive tape is in a form of a roll, a sheet, or a die-cut shape.

15. The fragrance duct tape according to claim 11, wherein the fragrance is in a form of an oil.

16. The fragrance duct tape according to claim 15, wherein the oil is encapsulated by a powder particle.

17. The fragrance duct tape according to claim 15, wherein the oil is encapsulated in a gelatin capsule.

18. The fragrance duct tape according to claim 11, wherein the fragrance is in a form of a powder.

19. The fragrance duct tape according to claim 11, wherein the fragrance is present in a liquid medium applied to the adhesive tape.

20. A method of making a fragrance adhesive tape, the method comprising:
applying a fragrance to an adhesive tape comprised of a base layer and an adhesive layer.

21. The method according to claim 20, wherein the adhesive tape further comprises a scrim.

22. The method according to claim 20, wherein the base layer is a polymer layer.

23. The method according to claim 20, wherein the fragrance is in a form of a powder.

24. The method according to claim 20, wherein the fragrance is in a form of an oil.

25. The method according to claim 20, wherein the fragrance is in a liquid medium.

26. A method of making a fragrance adhesive tape, the method comprising:
providing a fragrance oil and an inert powder material,
encapsulating the fragrance oil with the inert material to form an encapsulated powder particle,
applying the encapsulated powder particle to a surface or an edge of an adhesive tape.

27. The method according to claim 26, wherein the adhesive tape is a duct tape.

28. The method according to claim 26, wherein the adhesive tape is in the form of a roll, sheet, or a die-cut shape.

29. The method according to claim 26, wherein the particle is applied in a bath.

30. The method according to claim 26, wherein the inert powder material comprises a sugar, starch, gelatin, cellulose, or a combination thereof.

31. A method of making a fragrance adhesive tape, the method comprising:
providing a fragrance oil,
forming drops of the fragrance oil,
submerging the drops of the fragrance oil in a gelatin bath to form gelatin capsules comprising the fragrance oil, and
applying the gelatin capsules with a carrier to a surface or an edge of an adhesive tape.

32. The method according to claim 31, wherein the adhesive tape is a duct tape.

33. The method according to claim 31, wherein the adhesive tape is in the form of a roll, sheet, or die-cut shape.

34. The method according to claim 31, further comprising treating the gelatin capsules with an adhesive.

35. The method according to claim 31, further comprising spraying the gelatin capsules with the carrier on a surface or an edge of an adhesive tape.

36. The method according to claim 31, wherein the carrier is water or a water-based solution.

37. The method according to claim 36, wherein the gelatin capsules and water are in a slurry having a weight percent of solids in a range of 50% to 80%.

38. The method according to claim 37, wherein the weight percentage of solids is in a range of 65% to 75% solids.

39. The method according to claim 31, wherein the weight percent of core material in the gelatin capsule is in a range of 30% to 65%.

40. The method according to claim 39, wherein the weight percent of core material in the gel capsule is in a range of 45% to 60%.

41. A method of making an adhesive tape, the method comprising:
providing an inert powder material and an additive in a form of an oil,
encapsulating the additive with the inert material to form an encapsulated powder particle,
applying the encapsulated powder particle to a surface or an edge of an adhesive tape.

42. The method according to claim 41, wherein the adhesive tape is a duct tape.

43. The method according to claim 41, wherein the adhesive tape is in the form of a roll, sheet, or a die-cut shape.

44. The method according to claim 41, wherein the particle is applied in a bath.

45. The method according to claim 41, wherein the oil is a fragrance oil.

46. A method of making an adhesive tape, the method comprising:
providing an additive in a form of an oil,
forming drops of the oil,
submerging the drops of the oil in a gelatin bath to form gelatin capsules comprising the oil, and
applying the gelatin capsules to a surface or an edge of an adhesive tape.

47. The method according to claim 46, wherein the adhesive tape is a duct tape.

48. The method according to claim 46, wherein the adhesive tape is in the form of a roll, sheet, or die-cut shape.

49. The method according to claim 46, further comprising treating the gelatin capsules with an adhesive.

50. The method according to claim 46, further comprising spraying the gelatin capsules with a carrier on a surface or an edge of an adhesive tape.

51. The method according to claim 46, wherein the oil is a fragrance oil.
